(19) United States
(12) Patent Application Publication
(10) Pub. No.: US 2026/0017038 A1
(43) Pub. Date: Jan. 15, 2026

(54) CONTEXT AWARE MULTI-STAGE SOFTWARE BUILDS

(71) Applicant: International Business Machines Corporation, Armonk, NY (US)

(72) Inventors: Sudheesh S. Kairali, Kozhikode (IN); Sriram Srinivasan, San Jose, CA (US); Gopikrishnan Varadarajulu, Kundanahalli (IN); Joffin Johnson, Thrissur (IN)

(21) Appl. No.: 18/768,939

(22) Filed: Jul. 10, 2024

(51) Int. Cl. G06F 8/40

(52) U.S. Cl. CPC G06F 8/40

(57) ABSTRACT

A computer-implemented method according to one approach, is for customizing the selection of stages in a multi-stage software build. The computer-implemented method includes: using information associated with the multi-stage software build to develop situational context of the multi-stage software build. The situational context is converted into a build context and the build context is further converted into a number of build stages. Moreover, the build stages are automatically edited, and the edited stages are executed.

### BACKGROUND

The present invention relates to computer code, and more specifically, this invention relates to seamlessly performing code modifications.

Computer “code” refers to the set of instructions, or a system of rules, written in a particular programming language. Code can also refer to source code after it has been processed by a compiler and made ready to run on the computer. In addition to building computer programs and mobile applications, code is used heavily for innovative concepts such as artificial intelligence and machine learning.

Although code is developed in a particular configuration and/or for a particular application, it can be updated over time. An update to the code involves performing changes to the code itself that impact how the code operates. In other words, new code is used to replace older versions of the same code. These changes to the software are usually performed to fix bugs, address security vulnerabilities, provide new features, etc. For example, updating your operating system brings it up-to-date with the latest drivers, system utilities, and security software.

While performing updates to code allows for the code to adapt over time, updates are also a source of operating strain. For example, conventional products have struggled with replacing code seamlessly and reliably, particularly while attempting to replace references to a piece of code after it has been updated, particularly in multi-stage environments.

### SUMMARY

A computer-implemented method (CIM) according to one approach, is for customizing the selection of stages in a multi-stage software build. The CIM includes: using information associated with the multi-stage software build to develop situational context of the multi-stage software build. The situational context is converted into a build context and the build context is further converted into a number of build stages. Moreover, the build stages are automatically edited, and the edited stages are executed.

A computer program product (CPP), according to another approach, includes a set of one or more computer-readable storage media. The CPP also includes program instructions that are for customizing the selection of stages in a multi-stage software build. The program instructions are collectively stored in the set of one or more storage media, and are for causing a processor set to perform the foregoing CIM.

A computer system (CS), according to yet another approach, includes: a processor set, and a set of one or more computer-readable storage media. The CS further includes program instructions that are for customizing the selection of stages in a multi-stage software build. The program instructions are collectively stored in the set of one or more storage media, and are for causing the processor set to perform the foregoing CIM.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2A is a representational view of a distributed system, in accordance with one approach.

FIG. 2B is a partial representational view of a build layer, in accordance with one approach.

FIG. 3A is a flowchart of a method, in accordance with one approach.

FIG. 3B is a partial representational view of a situational context to build context converter, in accordance with one approach.

FIG. 3C is an illustrative table outlining the relationships between Build Contexts and Build Stages, in accordance with one approach.

FIG. 4 is a high level flowchart of a method, in accordance with an in-use example.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for customizing the selection of stages in a multi-stage software build based on situational context. The approaches herein may thereby evaluate and consider complexities introduced by situations that stem from the now prevalent “disconnected” nature of software development builds with production deployment in remote clustered environments. Approaches herein are desirably able to support both traditional software packages as well as software as a service (SaaS) deployments at the same release version levels, e.g., as will be described in further detail below.

In one general approach, a CIM is for customizing the selection of stages in a multi-stage software build. The CIM includes: using information associated with the multi-stage software build to develop situational context of the multi-stage software build. The situational context is converted into a build context and the build context is further converted into a number of build stages. Moreover, the build stages are automatically edited, and the edited stages are executed.

In another general approach, a CPP includes a set of one or more computer-readable storage media. The CPP also includes program instructions that are for customizing the selection of stages in a multi-stage software build. The program instructions are collectively stored in the set of one or more storage media, and are for causing a processor set to perform the foregoing CIM.

In yet another general approach, a CS includes: a processor set, and a set of one or more computer-readable storage media. The CS further includes program instructions that are for customizing the selection of stages in a multi-stage software build. The program instructions are collectively stored in the set of one or more storage media, and are for causing the processor set to perform the foregoing CIM.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved multi-stage build code at block 150 for customizing the selection of stages in a multi-stage software build (or “update”) based on situational context. The approaches herein may thereby evaluate and consider complexities introduced by situations that stem from the now prevalent “disconnected” nature of software development builds with production deployment in remote clustered environments. Approaches herein are desirably able to support both traditional software packages as well as SaaS deployments at the same release version levels, e.g., as will be described in further detail below.

In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

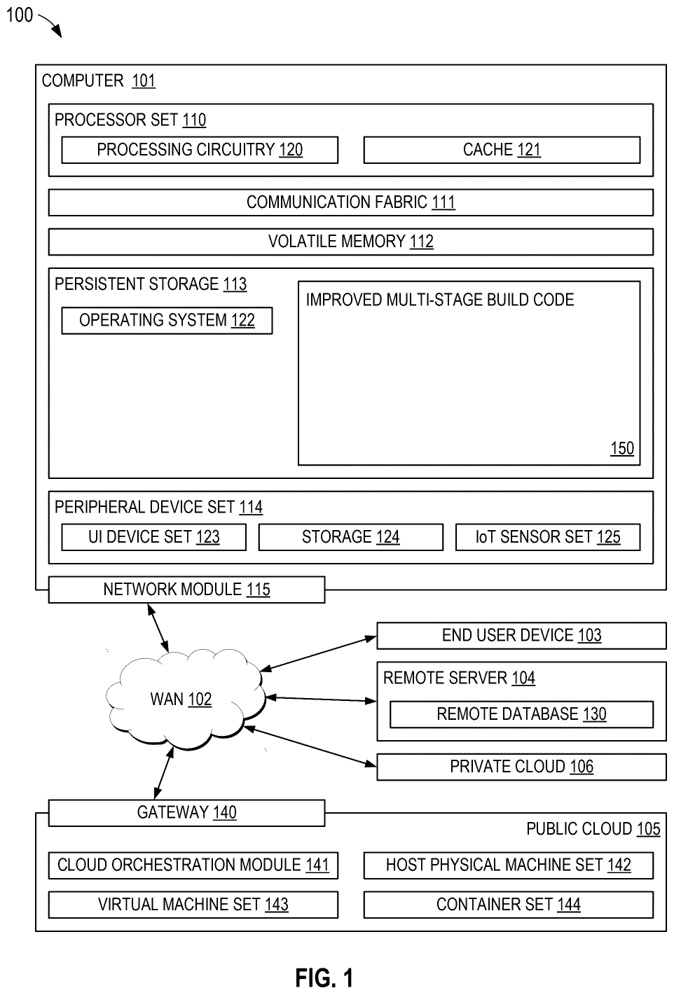

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is SaaS where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As noted above, computer code refers to the set of instructions, or a system of rules, written in a particular programming language, also referred to as “source code”. Code is also the term used for the source code after it has been processed by a compiler and made ready to run on the computer. In addition to building computer programs and mobile applications, code is used heavily for innovative concepts such as artificial intelligence and machine learning.

Although code is developed in a particular configuration and/or for a particular application, it can be updated over time. An update to the code involves performing changes to the code itself that impact how the code operates. In other words, new code is used to replace older versions of the same code. These changes to the software are usually performed to fix bugs, address security vulnerabilities, provide new features, etc. For example, updating your operating system brings it up-to-date with the latest drivers, system utilities, and security software.

A software “build” as used herein refers to the process of creating and packaging a working program in a manner that is easily distributable, e.g., for a software release. It is achieved by taking relevant source code files and further compiling them to create a build artifact (e.g., such as an executable, shared library, a DOCKER image, etc.). Such build procedures frequently involve handling multiple vendors or open-source dependencies at various version levels to maintain compatibility. According to an example, DOCKER images may be composed of multiple packages or binaries from different programming languages, themselves built using different techniques.

As the number of multiple components that are packaged continues to increase, builds become more time consuming and complex to orchestrate. For instance, software builds have become significantly complex compared to traditional builds done in a well-defined and dedicated machine/environment. Source code is now spread out and implements micro-service container-based architectures that produce an “assembly” of content.

With modular code development, there may be some aspects of the source code that is built from one branch, while other versions of the source code are from other branches, or even from other source code repositories. In other cases, additional packages, dependencies, binaries (e.g., such as shared libraries), etc. may picked-up as-is for a final assembly and/or to compile downstream binaries.

While building software, situations arise for which it is desirable to build from (e.g., off of) the latest source code. In other situations, it may be desirable to only rebuild parts of software that have been recently modified. Developers typically do not want to build some components that are unchanged and prefer to use a pre-built copy of the artifact of that component to avoid delay. Accordingly, some situations involve only building the specific changes and assembling an end package. In other situations, build pipelines involve building all pieces from scratch, not relying on any prior saved copies (or caches), e.g., as formal pipelines are built from well-marked snapshots of committed source code.

In traditional situations, where a handful of libraries or executables may be built, a simple Makefile for dependency tracking and the timestamp associated with .o object files versus their source code would have been sufficient to support incremental build involved. However, with the advent of multi-component, multi-programming language runtime container-image based micro-services, and the use of multiple source code repositories and branches, this problem has now led to developer and release inefficiencies. For example, building micro services for a software installation package where the same components are then to be pushed to a deployment in cloud. Given the nature of continuous integration and continuous delivery, as well as the performance issues caused by working outside a narrow disruption or maintenance windows, time is of the essence.

In sharp contrast, approaches herein are able to implement software builds and upgrades based on a specific context. For instance, approaches herein evaluate and consider complexities introduced by situations that stem from the now prevalent “disconnected” nature of software development builds with production deployment in remote clustered environments. Approaches herein are desirably able to support both traditional software packages as well as SaaS deployments at the same release version levels. Approaches herein are also able to build binaries for various different architectures.

This is achieved in some approaches by customizing the selection of stages in a multi-stage build based on situational context related to a software update. Approaches herein illustrate this improvement in the context of using SaaS (e.g., managed service on cloud) and/or software (on-prem) as two potential release targets for developer builds, e.g., for development testing as additional consumption of build artifacts. As used herein, a “build stage” refers to a specific step in a build or preparation process for an artifact intended to be assembled (e.g., included) in the final software release. It follows that approaches herein enable for build stages to be conveniently prebuilt or cached for quicker assembly or built from scratch for an end-to-end build-assembly of a software product. Approaches herein also importantly uniquely identify the version of each artifact as well as the provenance of that artifact. A simple example is a build or assembly process, that may have been triggered by a developer performing some unit testing, may select an older prebuilt version of an artifact rather than the latest in situations where the latest source of that artifact has serious regressions or may even fail to build. It is not efficient for a developer to wait for the entire assembly to be successful either. Just the build failure of one part of the entire assembly should not cause a complete blocker of day-to-day software development, e.g., as will be described in further detail below.

While a some of the approaches herein may be described in the context of using frameworks that implement JavaScript™M modules in a browser engine to process them, this is in no way intended to be limiting. Approaches herein may thereby be used to perform code updates in other programming languages. It should also be noted that the term “module” is intended to refer to the granularity of code that can be changed (e.g., updated), and each module further corresponds to a respective file, e.g., as would be appreciated by one skilled in the art after reading the present description. Approaches herein are able to perform module updates on the fly regardless of the number of modules being updated. For instance, approaches are able to perform “bundling” by loading multiple files at a time, thereby allowing for multiple modules to be defined together, rather than issuing a command for each file/module pair. However, a single module may be updated using any of the approaches herein.

Approaches are also able to load modules individually, even in situations where the modules are bundled together. This avoids working with unbundled source files, thereby further simplifying the development setup, and significantly impacting corresponding loading times. Approaches herein can also be achieved without implementing specific API(s), and can even work with a simple proxy server. These approaches take advantage of the fact that some code (e.g., like JavaScript™) operates as a prototype based language in order to ensure that all existing object instances pointing to the prototype of a previously loaded version are updated without any additional refresh step(s), e.g., as will be described in further detail below.

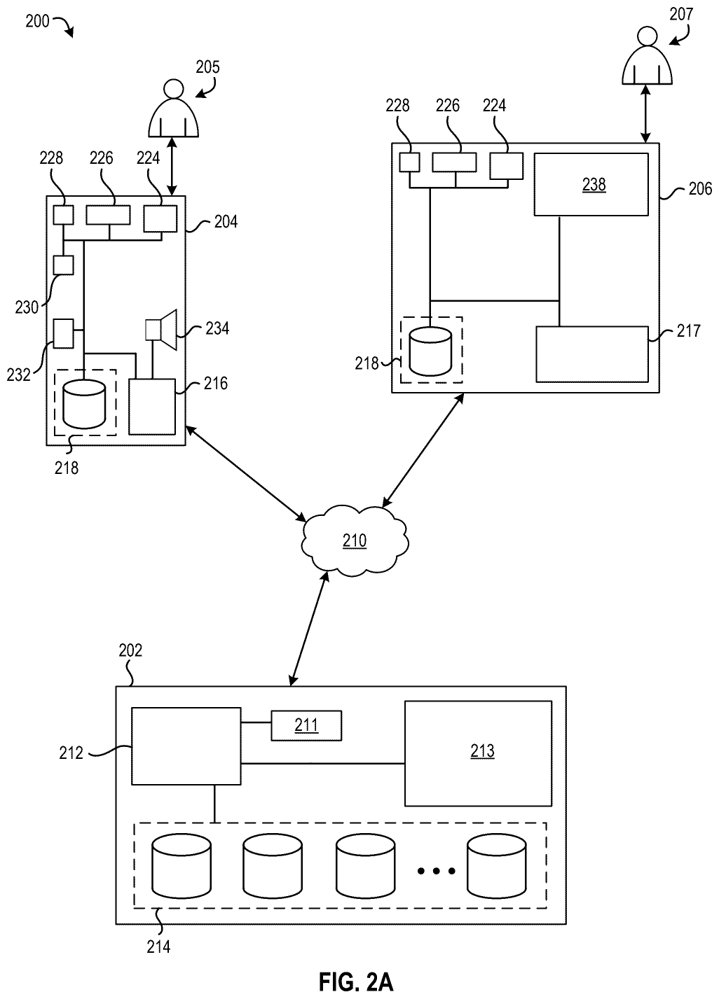

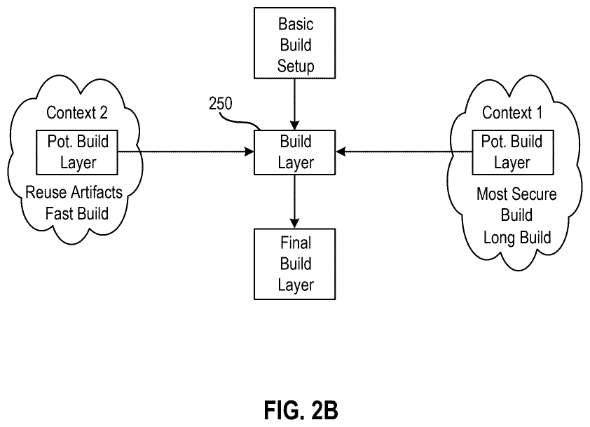

Looking now to FIG. 2A, a system 200 having a distributed architecture is illustrated in accordance with one approach. As an option, the present system 200 may be implemented in conjunction with features from any other approach listed herein, such as those described with reference to the other FIGS., such as FIG. 1. However, such system 200 and others presented herein may be used in various applications and/or in permutations which may or may not be specifically described in the illustrative approaches or implementations listed herein. Further, the system 200 presented herein may be used in any desired environment. Thus FIG. 2A (and the other FIGS.) may be deemed to include any possible permutation.

As shown, the system 200 includes a central server 202 that is connected to a user device 204, and edge node 206. The user device 204 is further accessible to the user 205, while the edge node 206 is assessable to developer 207. The user device 204 and/or the edge node 206 may thereby be considered “client devices,” each of which are connected to the central server 202. The central server 202, user device 204, and edge node 206 are each connected to a network 210, and may thereby be positioned in different geographical locations. In some approaches, the central server 202 orchestrates (e.g., manages) management service deployments that are made available to clients over network 210. However, in other approaches the central server 202 is connected to remote locations over network 210, and the remote locations implement the management service deployments that benefit from the updated software.

The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. As a result, any desired information, data, commands, instructions, responses, requests, etc. may be sent between user device 204, edge node 206, and/or central server 202, regardless of the amount of separation which exists therebetween, e.g., despite being positioned at different geographical locations. According to some approaches, the central server 202 is a remote cloud server that is connected to (e.g., may be accessed by) user device 204 and/or edge node 206.

However, it should be noted that two or more of the user device 204, edge node 206, and central server 202 may be connected differently depending on the approach. According to an example, which is in no way intended to limit the invention, two servers (e.g., nodes) may be located relatively close to each other and connected by a wired connection, e.g., a cable, a fiber-optic link, a wire, etc.; etc., or any other type of connection which would be apparent to one skilled in the art after reading the present description.

The terms “user” and “developer” are in no way intended to be limiting. For instance, while users and developers may be described as being individuals in various implementations herein, a user and/or a developer may be an application, an organization, a preset process, etc. in other approaches. The use of “data,” “datasets,” and “information” herein are in no way intended to be limiting either, and may include any desired type of details, e.g., depending on the type of operating system implemented on the user device 204, edge node 206, and/or central server 202.

With continued reference to FIG. 2A, the central server 202 includes a large (e.g., robust) processor 212 coupled to a cache 211, an artificial intelligence (AI) module 213, and a data storage array 214 having a relatively high storage capacity. The AI module 213 may include any desired number and/or type of AI-based models, e.g., such as machine learning models, deep learning models, neural networks, etc. In preferred approaches, the AI module 213 includes models that have been trained to correlate different situational contexts to respective build contexts. The AI module 213 preferably also includes models that have been trained to correlate different build contexts to respective multi-stage build stages.

For instance, referring momentarily to FIG. 2B, a build layer 250 is shown in accordance with one approach. The build layer 250 may be included in a processor (e.g., see processor 212 in FIG. 2A) and/or an AI based module (e.g., see AI module 213 of FIG. 2A). It follows that the present build layer 250 may be implemented in conjunction with features from any other embodiment listed herein, such as those described with reference to the other FIGS., such as FIG. 2A. However, such build layer 250 and others presented herein may be used in various applications and/or in permutations which may or may not be specifically described in the illustrative embodiments listed herein. Further, the build layer 250 presented herein may be used in any desired environment. Thus FIG. 2B (and the other FIGS.) may be deemed to include any possible permutation.

As shown, the build layer 250 receives Basic Build Setup information that corresponds to a change (e.g., update) in software. For instance, the Basic Build Setup information may include specific build stages that are to be changed, details input by a client, predetermined settings set by a developer, etc. The Basic Build Setup information is thereby evaluated and used to determine a general structure (e.g., overview) of the changes being made. For example, one or more AI based models trained to interpret setup information and compare it to potential (e.g., previously implemented) build layers.

Accordingly, build stages can be conveniently prebuilt, cached for quicker assembly, or built from scratch for an end-to-end build-assembly of a software product. The version of each artifact is also uniquely identifiable as well as the provenance of the respective artifact. A simple example is a build or assembly process, that may have been triggered by a developer performing some unit testing, may select an older prebuilt version of an artifact rather than the latest in situations where the latest source of that artifact has serious regressions or may even fail to build. It is not efficient for a developer to wait for the entire assembly to be successful either. Just the build failure of one part of the entire assembly should not cause a complete blocker of day-to-day software development, e.g., as will be described in further detail below.

The build layer 250 is thereby able to develop a Final Build Layer that may be a combination of newly formed build stages, reused build stages, previous build stages that have been altered, etc., depending on the approach. As noted above, this is achieved much more efficiently than has been conventionally achievable by evaluating input information and comparing it to preconfigured build stages to produce a complete “build” or software update, e.g., as would be appreciated by one skilled in the art after reading the present description.

Referring back now to FIG. 2A, user device 204 includes a processor 216 which is coupled to memory 218. The processor 216 receives inputs from and interfaces with user 205. For instance, the user 205 may input information using one or more of: a display screen 224, keys of a computer keyboard 226, a computer mouse 228, a microphone 230, and a camera 232. The processor 216 may thereby be configured to receive inputs (e.g., text, sounds, images, motion data, etc.) from any of these components as entered by the user 205. These inputs typically correspond to information presented on the display screen 224 while the entries were received. Moreover, the inputs received from the keyboard 226 and computer mouse 228 may impact the information shown on display screen 224, data stored in memory 218, information collected from the microphone 230 and/or camera 232, status of an operating system being implemented by processor 216, etc. The electronic device 204 also includes a speaker 234 which may be used to play (e.g., project) audio signals for the user 205 to hear. In some approaches, service requests, code updates, changes to a user interface, etc. may be submitted by user 205 using user device 204 and central server 202.

Looking now to the edge node 206, some of the components included therein may be the same or similar to those included in user device 204, some of which have been given corresponding numbering. For instance, controller 217 is coupled to memory 218, a display screen 224, keys of a computer keyboard 226, and a computer mouse 228. Additionally, the controller 217 is coupled to an AI module 238. As described above with respect to AI module 213, the AI module 238 may include any desired number and/or type of AI-based models, e.g., such as machine learning models, deep learning models, neural networks, etc. However, in preferred approaches the AI module 238 includes models that have been trained to correlate different situational contexts to respective build contexts. The AI module 213 preferably also includes models that have been trained to correlate different build contexts to respective multi-stage build stages. AI module 238 and/or controller 217 (and similarly AI module 213 and/or processor 212) may thereby be used to perform one or more of the operations in method 300 below to perform code module updates in a most efficient and accurate way possible, e.g., as will be described in further detail below.

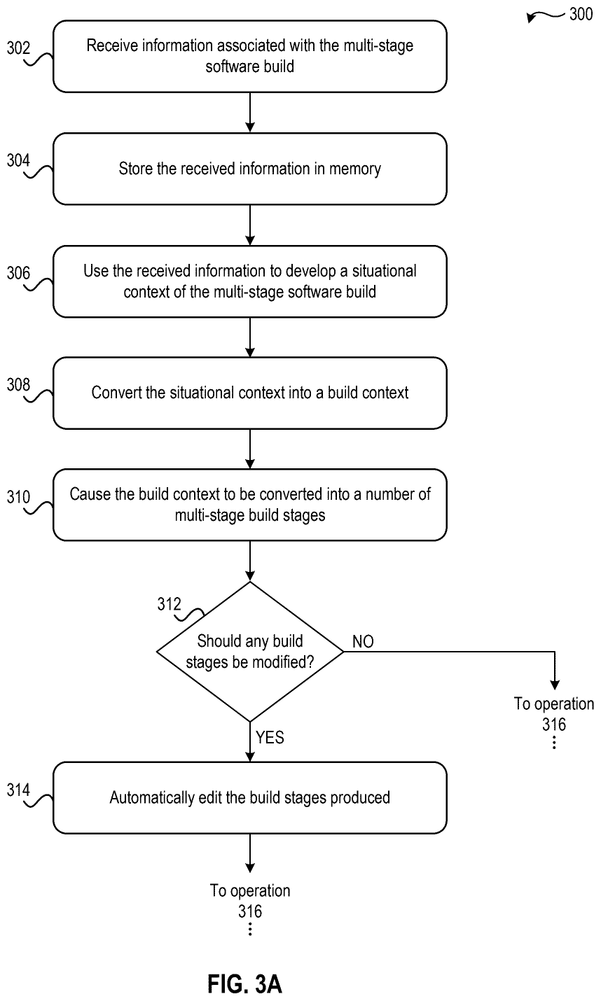

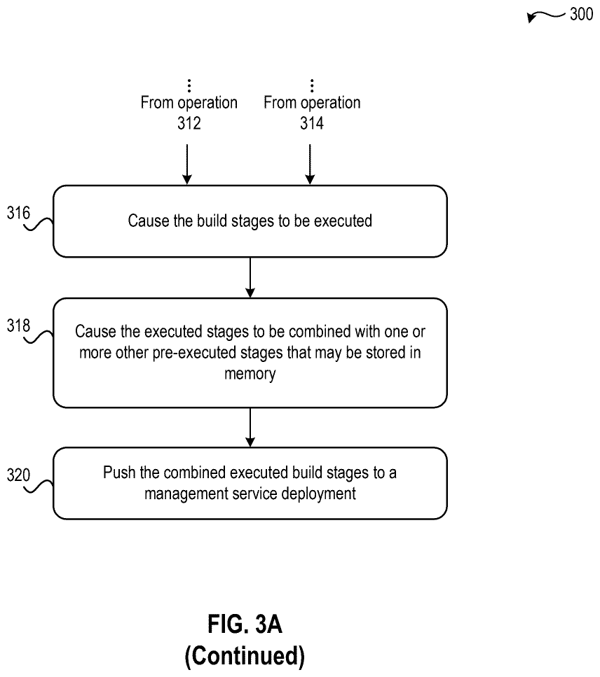

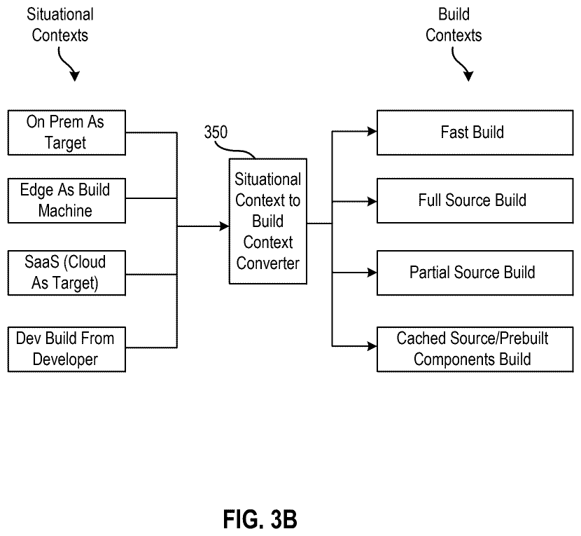

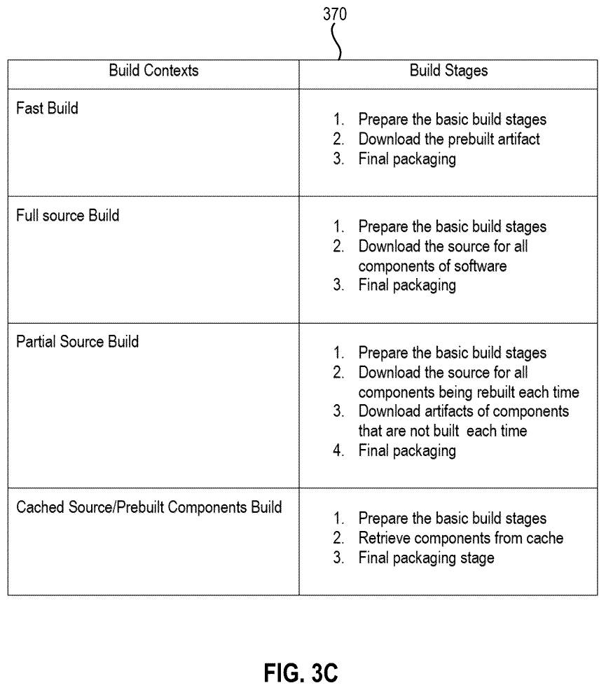

Looking now to FIG. 3A, a flowchart of a computer-implemented-method 300 for customizing the selection of stages in a multi-stage software build based on situational context is illustrated in accordance with one approach. In other words, method 300 includes updating code without actively creating all of the corresponding build stages. In some approaches, the software (e.g., code) being updated is a micro-service corresponding to a software installation package. The method 300 may be performed in accordance with the present invention in any of the environments depicted in FIGS. 1-2B, among others, in various embodiments. Of course, more or less operations than those specifically described in FIG. 3A may be included in method 300, as would be understood by one of skill in the art upon reading the present descriptions.

Each of the steps of the method 300 may be performed by any suitable component of the operating environment. For example, in some approaches one or more of the operations in method 300 may be performed by a controller configured to access and modify software code in developer environments (e.g., see controller 217 and/or processor 212 FIG. 2A), which may be supplemented by an AI based module (e.g., see AI modules 213 and/or 238 of FIG. 2A). However, the method 300 may be partially or entirely performed by a controller, a processor, a computer, etc., or some other device having one or more processors therein. Moreover, the terms computer, processor and controller may be used interchangeably with regards to any of the embodiments herein, such components being considered equivalents in the many various permutations of the present invention.

In some approaches, one or more of the operations in method 300 may be performed by an AI model that is trained using a predetermined training set of data. For example, in some approaches, various of the operations noted above may be deployed in a trained state of a trained AI model. Training of the AI model, in some approaches, may be performed by applying a predetermined training data set to learn how to correlate different situational contexts to respective build contexts and/or correlate different build contexts to respective multi-stage build stages. Initial training may include reward feedback in some approaches. As a result, AI models used in approaches herein are desirably trained to customize the selection of stages in a multi-stage software build based on situational context (e.g., such as business context). As noted above, the advent of multi-component, multi-programming language runtime container-image based micro-services, and the use of multiple source code repositories and branches, has increased the complexity of conventional products at an astonishing rate, leading to inefficiencies being realized in conventional products. Again, approaches herein overcome these inefficiencies by selectively building and/or rebuilding select build stages, and combining those build stages with known (e.g., stored) build stages, regardless of multi-stage build stages being at play. This has not been conventionally achievable.

To further prevent costs associated with relying on manual actions of a subject matter expert, in another approach, reward feedback may be implemented using techniques for training a BERT model, as would become apparent to one skilled in the art after reading the present disclosure. Once a determination is made that the AI model achieves a redeemed threshold of accuracy of performing the operations described herein during this training, a decision that the model is trained and ready to deploy for performing techniques and/or operations of method 300 may be performed. In some further approaches, the AI model may be a neuromyotonic AI model that may improve performance of computer devices in an infrastructure associated with approaches herein, because the neuromyotonic AI model may not need an SME and/or iteratively applied training with reward feedback in order to accurately perform operations described herein. Instead, the neuromyotonic AI model is configured to itself make determinations described in operations herein. Weight values may, in some approaches, be used by the AI reasoning model to collect and analyze information and/or feedback potentially received from previous software updates and related determinations. Such an AI model ensures that different situational contexts are correlated with respective build contexts and/or correlate different build contexts to respective multi-stage build stages.

As a result, AI models herein are desirably trained to customize the selection of stages in a multi-stage software build based on situational context (e.g., such as business context), where the scale of such analysis and determinations would not otherwise be feasible for a human to perform. This is because humans are not able to efficiently consider and apply the various details that are associated with building and/or modifying existing build stages based on software update information received, combine the built and/or modified build stages with existing (e.g., known) build stages to form the steps associated with completing the software update, and actually causing those combined build stages to be executed. Approaches herein would thereby otherwise incorporate processing delays and errors in this process of attempting to do so without the aid of trained AI based models, e.g., as described herein. Accordingly, management of operations described herein is not able to be achieved by human manual actions.

For those embodiments having a processor, the processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a FPGA, an AIU, a GPU, etc., combinations thereof, or any other suitable computing device known in the art.

As shown, operation 302 includes receiving information associated with the multi-stage software build. It follows that in some approaches, operation 302 includes receiving inputs that correspond to updating one or more modules of code. In other words, operation 302 includes receiving information (e.g., instructions, commands, metadata, etc.) that corresponds to performing a code update of varying size. Depending on the approach, the code update may be intended to add a feature to a software program that corresponds to the code, address an issue identified in the code, reflect previous performance, to reflect results generated by machine learning models based on evaluation(s) performed on data, etc. In some approaches, the software (e.g., code) being updated is a micro-service corresponding to a software installation package. Accordingly, the inputs received in operation 302 may outline the micro-service, related software installation package, planned updates thereto, etc.

The inputs received in operation 302 are typically received from a user (e.g., a developer), they may be received from one or more running applications, machine learning models, pre-programmed rules, etc. It also follows that the number of code modules that are ultimately updated as a result of receiving the inputs may vary. Thus, the information received in operation 302 is preferably sufficient to identify the one or more code modules that are intended to be updated. According to preferred approaches, the inputs include an identification (ID) and a Uniform Resource Locator (URL) for each of the modules being updated. The modules being updated may correspond to an Integrated Development Environment (IDE). Accordingly, the IDs and URLs that may be received in operation 302 are preferably compatible with an IDE constructed to implement the code updates.

In response to receiving the information, method 300 advances from operation 302 to operation 304. There, operation 304 includes storing the received information in memory. As noted above, the inputs preferably include a unique ID and URL pair for each respective code module being updated. Similarly, code modules that are not actually being modified by an update may be identified. The ID and URL pairs may be stored in local storage in some approaches, e.g., to increase accessibility and reduce latency. The inputs may be stored in a lookup table that incorporates each module of code in an organized fashion in some approaches. In some approaches the inputs are incorporated in and/or transformed into an AMD format, but any desired format may be used to save the received inputs. The IDE may thereby be configured to use (e.g., update) one or more AMD based modules, e.g., as would be appreciated by one skilled in the art after reading the present description. It should also be noted that the IDE may be configured differently depending on the approach. For instance, in some approaches the IDE is configured to implement JavaScript® software development, which is in no way intended to be limiting. Accordingly, IDE may be configured to implement an API that allows for interfacing with the code itself, e.g., such as requireJS.undef which again is in no way intended to be limiting.

While one or more specific modules of code may be identified by the inputs received in operation 302, operation 306 includes using the received information to develop a situational context of the multi-stage software build. In other words, the information associated with the multi-stage software build received in operation 302 is used to identify situational context that outlines the multi-stage software build. According to a non-limiting example, the situational context in some approaches is based at least in part on business context that has been extracted from the received information associated with the multi-stage software build. With respect to the present description, “business context” may include any software update patterns, repeating periods of high traffic, changes in client preferences, rise of identified security vulnerabilities, etc. It follows that knowing the business context associated with a particular software change (e.g., update) desirably allows for insight related to what the software update will generally involve (and not involve), allowing for connections to be made with preconfigured build stages. In some approaches, additional business contexts such as high security builds, high-performance optimized targeted builds, etc., may be identified from the received information associated with the multi-stage software build. Detection of business contexts may further be achieved via user input and/or using automatic detection logic. In some approaches, automatic detection logic that is able to determine whether a trigger is coming from a SaaS pipeline or elsewhere, e.g., as would be appreciated by one skilled in the art after reading the present description. Thus, as software continues to evolve, approaches herein provide an efficient and effective way to ensure locations have access to desired software.

From operation 306, method 300 advances to operation 308. There, operation 308 includes converting the situational context into a build context. In some approaches, operation 308 actually includes causing the situational context to be converted into a build context. For example, one or more instructions (e.g., commands, requests, etc.) may be sent to a situational context to build context converter. In other words, one or more instructions may be sent to a converter that is configured (e.g., has been trained) to transform the situational context into a build context.

The converter preferably includes the logic to convert business context into a set of build context. In some approaches, the situational context to build context converter includes one or more AI based models that have been trained to correlate different (e.g., various) situational contexts to respective build contexts. In some approaches, the AI based models are configured to correlate (e.g., map) an identified set of business context to an identified set of build context. In other approaches, the AI based models are configured to compare a newly identified set of business context to previous (e.g., identified) business contexts. The AI based models may thereby be able to develop new build contexts by combining portions of previously implemented build stages.

Referring momentarily to FIG. 3B, a situational context to build context converter 350 is illustrated in accordance with one approach. The converter 350 may be included in a processor (e.g., see processor 212 in FIG. 2A) and/or an AI based module (e.g., see AI module 213 of FIG. 2A). It follows that the present converter 350 may be implemented in conjunction with features from any other embodiment listed herein, such as those described with reference to the other FIGS., such as FIG. 3A. However, such converter 350 and others presented herein may be used in various applications and/or in permutations which may or may not be specifically described in the illustrative embodiments listed herein. Further, the converter 350 presented herein may be used in any desired environment. Thus FIG. 3B (and the other FIGS.) may be deemed to include any possible permutation.

As shown, the converter 350 receives various information that provides Situational Context. For instance, information explaining (e.g., outlining) whether a software update is being implemented locally (On Prem As Target), implemented at a distributed location (Edge As Build Machine), implemented at a central location (SaaS (Cloud As Target)), implemented in response to receiving instructions to build a dev branch of one more component in the software (Dev Build From Developer), etc. While a finite number of Situational Context entries are shown as being provided to the situational context to build context converter 350, this is in no way intended to be limiting. For example, the situational context to build context converter 350 may include one or more AI based models that have been trained to identify and interpret any situational context information from any desired source of information.

Accordingly, the situational context to build context converter 350 evaluates the various situational information, and ultimately produces one or more Build Contexts, e.g., as shown. For instance, a Fast Build involves a software build that is quickly completed. A Fast Build can pull all the pre-built components and package the latest software. Moreover, each component is built by separate builds and/or build pipelines. Pre-built components may also be available in a File Transfer Protocol (FTP) site, in a packaging repository (e.g., such as JFROG ARTIFACTORY), etc.

The Full Source Build involves downloading the entire source and building all the components, initially from the source, and subsequently packaging the software.

The Partial Source Build downloads desired components from a source. The Partial Source Build preferably builds the new corresponding components initially, and subsequently downloading the artifacts corresponding to rest of the components. For example, the existing artifacts may correspond to previous changes to the software, and stored in memory for future use.

Furthermore, the Cached Source/Prebuilt Components Build involves situations where a build machine has network availability issues. In such situations, the build machine preferably downloads, and caches required source or artifacts and download happens before actual build.

Additionally, the Custom Build & Assembly involves proof-of-concepts where a varying set of artifacts (and versions of artifacts) are assembled together for a special deployment. In other words, essentially a plug-n-play model is formed, where some artifacts are built from a modified source and others are perhaps picked from a pre-built version set. Note that some approaches operate under the impression that there is always source to be built and not just a packaging. Therefore, in this context, builds may be picking up a source code combination that is meant for a special purpose, e.g., as would be appreciated by one skilled in the art after reading the present description.

Again, while certain Build Contexts are shown in FIG. 3B, these are in no way intended to be limiting. Accordingly, more contexts can be added based on specific business or operating characteristics. For example, another build context may involve situations where compliance or regulatory thresholds (e.g., instructions) imply removal of certain components from the released version. In another example, the absence of a certain package may mean that such capabilities are not even buildable. In still another example, an ‘installer’ build may be implemented to achieve a software release, while unnecessary for a production cluster update in a SaaS model. In some approaches, two or more build contexts may be combined to produce a new (e.g., unique) combination of build stages. Hence a certain amount of intelligence can be coded into such specialized contexts as well.

With continued reference to FIG. 3B, it follows that the situational context to build context converter 350 is configured to (e.g., has been trained to) convert situational context information (e.g., such as business contexts including data movement patterns, manufacturing standards, predetermined preferences, network traffic overviews, etc., to build contexts. In some approaches, one or more models may be trained to apply a mapping between the situational contexts and the respective build contexts. For example, an Edge As Machine Build situational context may be mapped to the Cached Source/Prebuilt Components Build. In another example, the Developer Build situational context may be mapped to the Partial Source Build. In some approaches, an administrator, client, AI based model, etc. may provide inputs that ultimately are used to produce the mapping between situational contexts and build contexts.

Referring back now to FIG. 3A, method 300 advances from operation 308 to operation 310 in response to the situational context being converted into a build context. There, operation 310 includes causing the build context to be converted into a number of multi-stage build stages. In other words, operation 310 includes converting the build context produced in operation 308 into a number of build stages that outline the steps that are to be executed in order to achieve the desired change to the base software.

The build context is preferably converted into the multi-stage build stages using a using a build context to multi-stage build stages converter. As mentioned above, the build context to multi-stage build stages converter may be trained to make correlations between various build contexts and their respective build stages. These correlations may be based on predetermined relationships, dynamic analysis of performance data received in real-time (e.g., periods of high throughput may cause a build context to be converted into a set of build stages that are less compute intensive than another set of build stages that produces the same or similar update to the base software), etc.

Referring momentarily to FIG. 3C, an illustrative table 370 outlining the relationships between Build Contexts and the corresponding Build Stages is illustrated in accordance with one approach. The table 370 may be used to train one or more AI based models. Accordingly, table 370 may be included in a processor (e.g., see processor 212 in FIG. 2A) and/or an AI based module (e.g., see AI module 213 of FIG. 2A). However, such table 370 and others presented herein may be used in various applications and/or in permutations which may or may not be specifically described in the illustrative embodiments listed herein. Further, the table 370 presented herein may be used in any desired environment. Thus FIG. 3C (and the other FIGS.) may be deemed to include any possible permutation.

As shown, the table 370 includes a number of Build Contexts that are mapped to a number of corresponding Build Stages. The Build Contexts and Build Stages shown in FIG. 3C are in no way intended to be limiting and are presented by way of example only. For example, the process of converting the Build Contexts into a number of Build Stages allows for any custom build stages to be added and/or replace existing stages. This allows for approaches herein to achieve a desired final software implementation that offers any desired features and/or functionality. For instance, an administrator may introduce a compression build stage that is configured to reduce the size of involved data (e.g., images) and build output due to the network constraints in the context. In another example, an administrator may introduce an encryption build stage that is configured to encrypt (e.g., protect) sensitive data such that it may be sent over a public network without being exposed. Again, by focusing on modifying and/or adding specific build stages, and merging known build stages (or the results thereof) where changes are not made in a multi-stage environment, approaches herein are able to significantly reduce the latency and throughput associated with actually performing multi-stage software builds.

Returning to FIG. 3A, operation 310 again includes causing the build context to be converted into a number of multi-stage build stages. It should be noted that operation 310 may thereby involve sending one or more instructions that ultimately cause a build context to build stage converter to generate the build stages. From operation 310, method 300 advances to operation 312. There, operation 312 includes reviewing the produced build stages and determining whether any of the stages warrant being edited. In other words, the build stages produced in operation 310 (e.g., by trained AI based model(s)) may not be a desired combination, may not take details into consideration, may violate one or more preestablished relationships, etc.

In response to determining that one or more of the multi-stage build stages does need to be edited, method 300 advances from operation 312 to operation 314. There, operation 314 includes automatically editing the build stages produced by the converter in operation 310. In other words, operation 310 includes optimizing the number, order, type, etc., of the build stages that are included, such that executing the build stages produces an intended result. In some approaches, the build stages produced in operation 310 may be received from the build context to multi-stage build stages converter, and accumulated in a cache. Accordingly, in some approaches operation 314 includes modifying the build stages locally. In other approaches, one or more instructions may be sent in operation 314 that result in the produced build stages to be modified before execution. In some approaches, the stages generated for each situational context can be validated by a system administrator for accuracy. Moreover, the stages mapping can be continuously updated based on these validations. In some approaches the validation is performed automatically. According to a non-limiting example, fast stages are considered fast based on one or more predetermined thresholds.

Proceeding from operation 314, method 300 advances to operation 316. There, operation 316 includes causing the build stages to be executed. However, method 300 also advances to operation 316 directly from operation 312. Thus, operation 316 essentially includes causing the resulting combination of build stages to be executed. In some approaches, one or more instructions may be sent to a processor, compiler, etc., that results in the desired build stages being executed.

Updated software is produced in response to the desired build stages being executed. Accordingly, operation 318 further includes causing the executed stages to be combined with one or more other pre-executed stages that may be stored in memory. As noted above, it may be undesirable for all modules of software code to be updated. Accordingly, rather than re-executing build stages (or software modules) that are unchanged, approaches herein may combine new and/or modified build stages that are executed with known (e.g., stored) build stages. This allows for the software as a whole to be updated in a more efficient manner than has conventionally been achievable. Furthermore, operation 320 includes pushing the combined executed build stages to a management service deployment. In other words, operation 320 includes sending out the updated software for implementation at a client location, at an accessible location in cloud (e.g., at a cloud-based location), etc.

It follows that approaches herein are desirably able to weigh a number of factors, e.g., such as what challenges are associated with performing software updates at an edge location, which might have challenges in terms of connectivity. Approaches herein are also able to determine on the fly whether complete source code be downloaded and built, in comparison to only certain portions (e.g., modules). Approaches herein also consider (e.g., implement AI based models that have been trained to evaluate) whether only certain code modules are supported, whether movement patterns based on the network availability are present. Approaches herein also consider whether build machines should be as close as possible to the “production” clusters, what happens if production clusters are in multiple data center locations, whether builds and CI/CD pipelines are able to handle both “SaaS” and Software releases, etc.

While the use of multi-stage builds and incremental or context sensitive assembly of artifacts provides an initial idea of how this may be achieved, conventional products are simply unable to even consider the various factors identified herein. For example, existing techniques do not help with the decision of which stages to be included in builds and what kind of stages should be included in build, much less how it is interlinked with varying dynamic context.

Again, approaches herein are desirably able to convert situational context information into build contexts. For example, some approaches evaluate business contexts while building a context converter in the build process. This could be done between identified finite set of business context to finite set of build context. A converter may thereby be provided with the logic to convert the finite set of business context to the finite set of build context. Moreover, a multi-stage build will have various stages to execute, and at least some of the stages may consume the output of the previous respective stages. In response to generating the build contexts, they are further converted to various stages to be executed in the multi-stage build.

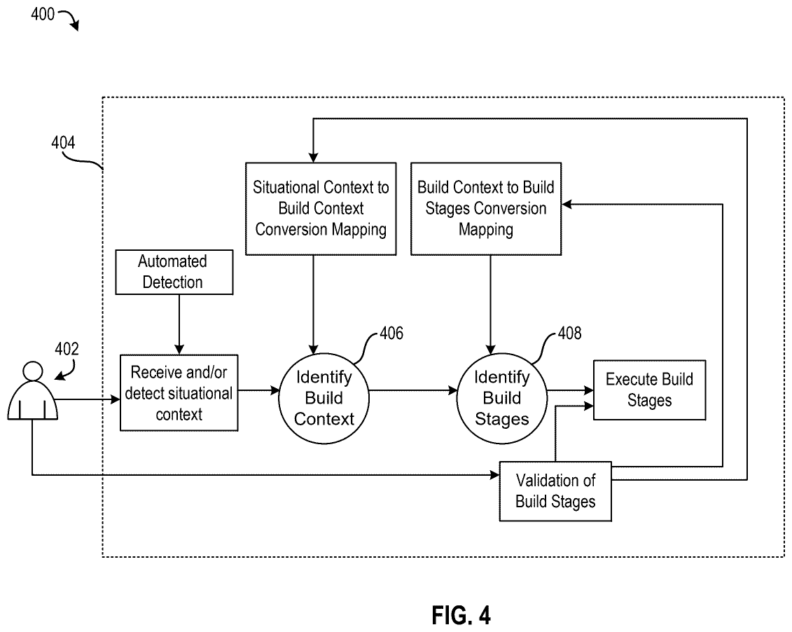

Referring now to FIG. 4, a high level method 400 of updating (or “building”) software is illustrated according to an in-use example which is in no way intended to be limiting. As shown, a user (e.g., client) 402 provides input to a processor 404 that includes a number of logical and/or physical components therein. The inputs provided by user 402 may correspond to a software update.

Inputs received from user 402 are evaluated using Automated Detection. As a result, situational context is extracted from the received information from user 402. The situational context is thereby provided to a converter 406. The converter 406 is preferably a situational context to build context converter that is trained to convert situational contexts into corresponding build contexts. In some approaches, the converter 406 references information stored in the Situational Context to Build Context Conversion Mapping.

The build context produced by converter 406 is thereby passed to converter 408. There, converter 408 converts the build context into various build stages. In some approaches, the converter 408 references information stored in the Build Context to Build Stages Conversion Mapping. From converter 408, the build stages may be reviewed by user 402, compared to one or more predetermined guidelines, etc., in order to determine whether the build stages produced by converter 408 need to be modified before being executed. Accordingly, once the build stages have been verified, Validation of Build Stages is provided, and the build stages are executed before being sent to a deployment, e.g., as would be appreciated by one skilled in the art after reading the present description. For example, a build stage executor may be used to execute the final combination of build stages.

Furthermore, information outlining whether the produced build contexts and/or build stages are actually used, modified before use, canceled before execution, etc., is passed back to the Situational Context to Build Context Conversion Mapping and the Build Context to Build Stages Conversion Mapping. Accordingly, AI based models that have been trained using the Situational Context to Build Context Conversion Mapping and/or the Build Context to Build Stages Conversion Mapping may be retrained over time as new information is received in response to software updates being implemented. This allows for the system to maintain an accurate understanding of the patterns and intricacies of how software updates are implemented, allowing for software updates to be performed more efficiently than conventionally achievable, e.g., as described herein.

Again, approaches herein are desirably able to provide build contexts that may be validated and even modified (e.g., undergo optimization of stages), by validating the stages generated for each situational (e.g., business) context for accuracy and continuously. Moreover, the stages are continually mapped and updated based on these validations.

Approaches herein facilitate business context to build context converters in the build process which could be done between identified finite set of business context to finite set of build context. A converter will thereby have the logic to convert the finite set of business context to the finite set of build context. Approaches are also able to provide build contexts, such as, but not limited to, fast build, full source build, partial source build, cached source/pre-built components build. Approaches herein facilitate (e.g., train) a build context to multi staging build stages converter, where a multistage build will have various stages to execute, and each stage can consume the output of previous stage and converting contexts to various stages to be execute in the multistage build once build contexts are generated.

It will be clear that the various features of the foregoing systems and/or methodologies may be combined in any way, creating a plurality of combinations from the descriptions presented above.

It will be further appreciated that implementations of the present invention may be provided in the form of a service deployed on behalf of a customer to offer service on-demand.

The descriptions of the various implementations of the present invention have been presented for purposes of illustration, but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical improvement over technologies found in the marketplace, or to enable others of ordinary skill in the art to understand the implementations disclosed herein.

What is claimed is:

1. A computer-implemented method (CIM) for customizing the selection of stages in a multi-stage software build, comprising:
using information associated with the multi-stage software build to develop situational context of the multi-stage software build;
causing the situational context to be converted into a build context;
causing the build context to be converted into a number of build stages;
automatically editing the build stages; and
causing the edited stages to be executed.

2. The CIM of claim 1, wherein the causing of the situational context to be converted into a build context includes causing a situational context to build context converter to generate the build context.

3. The CIM of claim 2, wherein the situational context to build context converter includes an artificial intelligence based model trained to correlate different situational contexts to respective build contexts.

4. The CIM of claim 1, wherein the causing of the build context to be converted into a number of build stages includes causing a build context to build stage converter to generate the build stages.

5. The CIM of claim 4, wherein the build context to build stage converter includes an artificial intelligence based model trained to correlate different build contexts to respective multi-stage build stages.

6. The CIM of claim 1, wherein the situational context is based on business context extracted from the received information.

7. The CIM of claim 1, further comprising:
causing the executed stages to be pushed to a service deployment,
wherein the multi-stage software build is a micro-service corresponding to a software installation package.

8. The CIM of claim 7, wherein the service deployment is cloud-based.

9. A computer program product (CPP), comprising:
a set of one or more computer-readable storage media; and
program instructions for customizing the selection of stages in a multi-stage software build, the program instructions collectively stored in the set of one or more storage media, for causing a processor set to perform the following computer operations:
use information associated with the multi-stage software build to develop situational context of the multi-stage software build;
cause the situational context to be converted into a build context;
cause the build context to be converted into a number of build stages;
automatically edit the build stages; and
cause the edited stages to be executed.

10. The CPP of claim 9, wherein the causing of the situational context to be converted into a build context includes causing a situational context to build context converter to generate the build context.

11. The CPP of claim 10, wherein the situational context to build context converter includes an artificial intelligence based model trained to correlate different situational contexts to respective build contexts.

12. The CPP of claim 9, wherein the causing of the build context to be converted into a number of build stages includes causing a build context to build stage converter to generate the build stages.

13. The CPP of claim 12, wherein the build context to build stage converter includes an artificial intelligence based model trained to correlate different build contexts to respective multi-stage build stages.

14. The CPP of claim 9, wherein the situational context is based on business context extracted from the received information.

15. The CPP of claim 9, wherein the program instructions are for causing the processor set to further perform the following computer operations:
cause the executed stages to be pushed to a service deployment,
wherein the multi-stage software build is a micro-service corresponding to a software installation package.

16. The CPP of claim 15, wherein the service deployment is cloud-based.

17. A computer system (CS), comprising:
a processor set;
a set of one or more computer-readable storage media; and
program instructions for customizing the selection of stages in a multi-stage software build, the program instructions collectively stored in the set of one or more storage media, for causing the processor set to perform the following computer operations:
use information associated with the multi-stage software build to develop situational context of the multi-stage software build;
cause the situational context to be converted into a build context;
cause the build context to be converted into a number of build stages;
automatically edit the build stages; and
cause the edited stages to be executed.

18. The CS of claim 17, wherein the causing of the situational context to be converted into a build context includes causing a situational context to build context converter to generate the build context, wherein the situational context to build context converter includes an artificial intelligence based model trained to correlate different situational contexts to respective build contexts.

19. The CS of claim 17, wherein the causing of the build context to be converted into a number of build stages includes causing a build context to build stage converter to generate the build stages, wherein the build context to build stage converter includes an artificial intelligence based model trained to correlate different build contexts to respective multi-stage build stages.

20. The CS of claim 17, wherein the program instructions are for causing the processor set to further perform the following computer operations:
cause the executed stages to be pushed to a service deployment,
wherein the multi-stage software build is a micro-service corresponding to a software installation package,
wherein the service deployment is cloud-based,
wherein the situational context is based business context extracted from the received information.
